(19) United States
(12) Patent Application Publication
(10) Pub. No.: US 2017/0081210 A1
(43) Pub. Date: Mar. 23, 2017

(54) SOLAR WASTEWATER DISINFECTION SYSTEM AND METHOD

(71) Applicant: Pasteurization Technology Group, Inc., San Leandro, CA (US)

(72) Inventors: Gregory RYAN, Mill Valley, CA (US); Vlad KALIKA, Dublin, CA (US); Antoine ALTASSERRE, San Francisco, CA (US)

(21) Appl. No.: 14/858,452

(22) Filed: Sep. 18, 2015

(51) Int. Cl. C02F 1/02

(52) U.S. Cl. CPC C02F 1/02

(57) ABSTRACT

A solar wastewater disinfection system and method, the system including a solar collector configured to heat wastewater from a first temperature up to at least a second temperature, using solar energy; a pre-heater configured to heat the wastewater up to at least the first temperature, by transferring heat from the wastewater heated by the solar collector; a pump configured to circulate the wastewater between the pre-heater and the solar collector; and a controller configured to control the pump, such that the wastewater remains at or above the second temperature for a time period sufficient to pasteurize the wastewater.

### FIELD

The present invention is generally directed to a wastewater disinfection system, and more particularly, to a solar wastewater disinfection system configured to pasteurize wastewater using solar energy.

### BACKGROUND OF THE INVENTION

Traditional methods of wastewater disinfection are chlorination and UV irradiation. Chlorine is highly toxic and requires de-chlorination before water is discharged. UV irradiation systems consume large amounts of electrical energy and require low water turbidity to be effective.

Pasteurization is the process of heating a liquid to a specific temperature for a specific time for the purpose of destroying microorganisms that can cause disease, spoilage or fermentation. Pasteurization in water, food and beverage processing falls into four general categories: Vat (63° C. for 30 minutes), high-temperature, short-time (72° C. for 15 seconds), higher-heat short-time (89° C. for 1.0 second) and Ultra Pasteurization (138° C. for 2.0 seconds).

Pasteurization is typically conducted at low water volumes, such as in campsites and other remote, rural locations. Small, portable solar water pasteurization units, or solar cookers, are sometimes used for pasteurizing water from solar heat. Generally, pasteurization is not used for large-scale water treatment, due to the high costs associated with heating large amounts of water.

Accordingly, there is a need for a large-scale wastewater disinfection system that can operate with reduced heating costs.

### SUMMARY OF THE INVENTION

Exemplary embodiments of the present disclosure are directed to a solar wastewater disinfection system comprising: a solar collector configured to heat wastewater from a first temperature up to at least a second temperature, using solar energy; a pre-heater configured to heat the wastewater up to at least the first temperature, by transferring heat from the wastewater heated by the solar collector; a pump configured to circulate the wastewater between the pre-heater and the solar collector; and a controller configured to control the pump, such that the wastewater is maintained at least at the second temperature for a time period sufficient to disinfect the wastewater.

Exemplary embodiments of the present disclosure are directed to a method of disinfecting wastewater, comprising: heating wastewater from a first temperature to at least a second temperature using heat from a solar collector; maintaining the wastewater at least at the second temperature, for a time period sufficient to disinfect the wastewater; and heating incoming wastewater to at least the first temperature using heat extracted from the disinfected wastewater.

### BRIEF DESCRIPTION OF THE DRAWINGS

FIG. 1 is a schematic representation of a wastewater disinfection system, according to various embodiments of the present disclosure.

FIG. 2 is a schematic representation of a wastewater disinfection system, according to various embodiments of the present disclosure.

FIG. 3 is a schematic of components of a secondary heat source that may be included in the system of FIG. 1, according to various embodiments of the present disclosure.

FIGS. 4A and 4B respectively illustrate heat exchangers that may be included in the wastewater disinfection systems of FIGS. 1 and 2.

FIG. 5 is a block diagram illustrating a method of disinfecting wastewater, according to various embodiments of the present disclosure.

### DETAILED DESCRIPTION OF THE EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being disposed “on” or “connected to” another element or layer, it can be directly on or directly connected to the other element or layer, or intervening elements or layers may be present. In contrast, when an element is referred to as being disposed “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Herein, “pasteurization” may be considered a particular type of disinfection process. As such, “pasteurization” and “disinfection” may be used interchangeably herein.

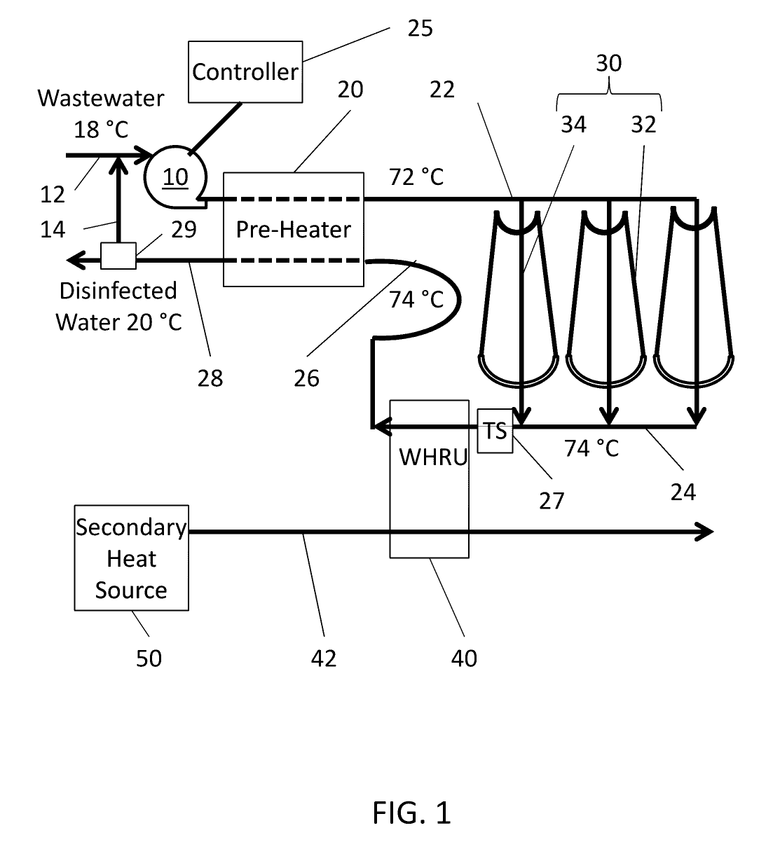

FIG. 1 is a schematic diagram of a wastewater disinfection system, according to various embodiments of the present disclosure. Referring to FIG. 1, the system includes a pump 10, a pre-heater 20, a controller 25, and a solar collector 30. The system may also optionally include waste heat recovery unit (“WHRU”) 40 and a secondary heat source 50.

An input conduit 12 may connect the pump 10 to a source of untreated wastewater. The wastewater entering the pump 10 may be approximately room temperature, (e.g., about 18° C.). The pump 10 may pump the wastewater to the pre-heater and/or though the system. The pump 10 may be a single pump or may include multiple pumps.

The pre-heater 20 may be a heat exchanger, such as a shell and tube heat exchanger, a plate and frame heat exchanger, or a bronzed plate heat exchanger. In some embodiments, the pre-heater may include multiple heat exchangers and/or heat exchange plates. For example, the pre-heater may be a plate and frame heat exchanger, designed to heat the wastewater to a first temperature approaching a pasteurization temperature. For example, if the system is configured for high-temperature short-time pasteurization, the pre-heater 20 may heat the wastewater to a first temperature ranging from about 67 to about 77° C., such as a first temperature ranging from about 69 to about 75° C., a first temperature ranging from about 70 to about 74° C., including a first temperature of about 72° C.

After passing through the pre-heater 20, the pre-heated wastewater enters the solar collector 30, via a distribution conduit 22. In particular, the distribution conduit 22 may connect an outlet of the pre-heater 20 to an inlet of the solar collector 30. The distribution conduit 22 may be a manifold configured to divide the wastewater into multiple streams. The solar collector 30 may be any suitable type of solar collection apparatus, such as a flat-plate collector, an evacuated tube collector, or a parabolic trough collector.

Flat plate collectors may include a flat and thin sheet that absorbs solar energy and transmits it to a fluid circulating inside a coil or a grid of tubes. A transparent cover and a heat insulating backing are generally installed on top of and underneath the absorber to reduce heat losses.

Evacuated tube collectors may be absorption conduits that include a transparent glass enclosure into which a heat conduit absorbs solar energy and transmits it to a fluid. The space in between the enclosure inside wall and the heat conduit outside wall is under vacuum, in order to minimize convection and conduction heat losses. The vacuum also contributes to maintaining the selective coating performance, by minimizing degradation due to environmental exposure. A selective coating is typically applied onto the solar energy absorbing surface, in order to increase absorptivity and reduce emissivity.

For example, in some embodiments the solar collector 30 may include a field of parabolic trough reflectors 32 configured to concentrate sunlight on absorption conduits 34 disposed in the troughs. In particular, the reflectors 32 may be configured to concentrate light onto lower surfaces of the absorption conduits 34, thereby heating the wastewater in the absorption conduits 34.

Wastewater plants typically have ponds used for water collection, aeration and settling. According to various embodiments, the solar collector 30 may be floated on such a storage, settlement, or aeration wastewater pond, using a floatation device disposed under the solar collector 30. Therefore, the land usage of the solar collector 30 may be reduced, as compared to a terrestrial solar collector. However, the present disclosure also encompasses terrestrial solar collector applications.

The pre-heated wastewater may be heated in the absorption conduits to a second temperature (e.g., a pasteurization temperature) ranging from about 65 to about 77° C. For example, if the system is configured for high-temperature short-time pasteurization, the wastewater may be heated to a second temperature ranging from about 70 to about 80° C., such as a second temperature ranging from about 72 to about 76° C., or a second temperature of about 74° C. The waste water may be maintained at such a second temperature a time period (e.g., residence time) ranging from about 5 to about 25 seconds, such as a time period ranging from about 10 to about 20 seconds, or about 15 seconds. However, the present disclosure is not limited to any particular second temperature and/or time period, so long as the wastewater is adequately disinfected (e.g., pasteurized). For example, at higher temperatures, a shorter residence time may be used, and at lower temperatures, a longer residence time may be used.

According to various embodiments, the second temperature may be higher than the first temperature. For example, the second temperature may range from about 1 to about 8° C. higher than the first temperature, such as from about 1 to about 6° C. degrees higher, from about 1 to about 4° C. higher, including from about 1 to about 2° C. higher. The proximity of the first and second temperatures may reduce the amount of heating needed from the solar collector 30.

The heated wastewater is then collected by a return conduit 24 and provided to the pre-heater 20. The absorption conduits 34 and/or the distribution and collection conduits 22, 24 may be sized to achieve a particular residence time at pasteurization temperatures. For example, the length and/or diameters of the conduits may be set to achieve a particular wastewater flow rate and a corresponding residence time. In addition, the pump 10 may be used to control the flow rate of the wastewater to achieve a particular residence time at pasteurization temperatures.

The system may optionally include a contact chamber 26 which may increase the residence time of the wastewater at pasteurization temperatures. The contact chamber 26 may be an insulated conduit having a larger diameter than the other conduits of the system (e.g., conduits 22, 24). Accordingly, the contact chamber 26 may reduce the velocity of the wastewater in the system and thereby increase the residence time of the wastewater at pasteurization temperatures. However, in some embodiments, the contact chamber 26 may be omitted.

Once the wastewater has been sufficiently disinfected, the wastewater is provided to the pre-heater 20. In the pre-heater, heat from the disinfected wastewater is transferred to the incoming unpasteurized wastewater. As such, the pre-heater 20 operates to recycle the thermal energy within the system, thereby reducing the amount of solar energy collection and/or residence time needed by the solar collector 30 to heat the wastewater to pasteurization temperatures.

Due to the heat transfer in the pre-heater 20, the wastewater exiting the pre-heater 20 may have a temperature ranging from about 15 to about 25° C., such as a temperature ranging from about 17 to about 23° C., including a temperature of about 20° C. The disinfected wastewater is then provided to a discharge conduit 28, where the disinfected wastewater may be non-potable water provided for external uses, such as irrigation and/or gray water applications.

According to various embodiments, the system may be configured to heat the wastewater to a temperature of below 100° C., at least between the pump 10 and the return conduit 28, e.g., between the distribution conduit 22 and the collection conduit 26. In particular, the system may be configured such that the heating does not boil and/or intentionally evaporate the wastewater. Further, the system may not include a dedicated evaporator and/or a condenser.

The system may optionally include a recycling conduit 14 connecting the discharge conduit 28 to the input conduit 12. During startup, wastewater exiting the pre-heater 20 may be fed through the recycling conduit 14, in order to more rapidly bring the system up to operating temperatures. For example, the wastewater may be fed through the system in a closed loop using the recycling conduit 14 and by actuating a valve 29, until the waste water reaches a temperature sufficient for pasteurization.

The controller 25 may include a central processing unit and a memory. For example, the controller 25 may be a server or a general purpose computer, loaded with appropriate control software. The controller 25 may be integrated with the system, or may be electrically connected to the system from a remote location.

The controller 25 may be configured to control the pump 10, such that the flow rate of the wastewater through the system is as high as possible, while providing a wastewater residence time in the system sufficient for a selected level of disinfection/pasteurization. According to some embodiments, the controller 25 may be connected to one or more temperature sensors incorporated into one or more of the conduits. For example, the controller 25 may be connected to a temperature sensor 27 configured to detect the temperature of the wastewater in the collection conduit 24. However, the system may include temperature sensors at other locations, such as within conduits 22, 24, 26, and/or 28.

The controller 25 may be configured to control the pump 10 according to the detected temperature, such that the waste water is maintained at a disinfection (e.g. pasteurization) temperature for a corresponding amount of time sufficient to adequately disinfect the wastewater. For example, the controller 25 may use the temperature of the wastewater exiting the solar collector 30, the length and/or diameter of the collection conduit, and/or the length and/or diameter of the contact chamber 26 if included, in order to determine a corresponding speed of the pump 10.

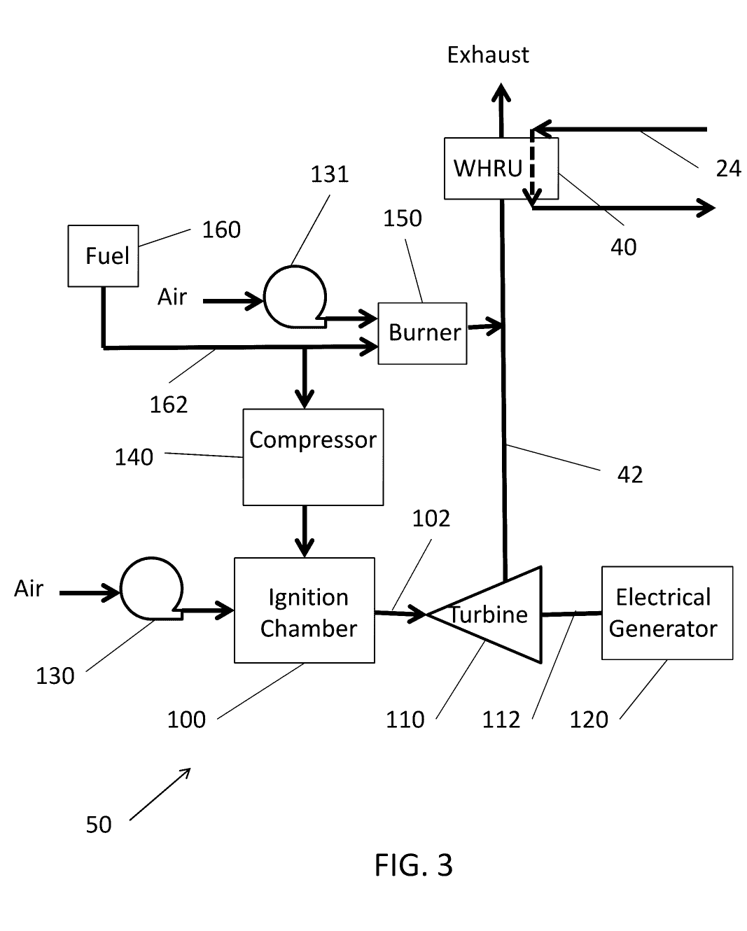

According to various embodiments, an exhaust/thermal conduit 42 may connect the optional secondary heat source 50 and WHRU 40. The secondary heat source 50 may be a burner, or may encompass exhaust gasses from a generator such as a gas turbine or reciprocating engine. In some embodiments, the secondary heat source 50 may be a combined heat and power system, as discussed below with regard to FIG. 3.

The WHRU 40 may be configured to transfer heat from the exhaust conduit 42 to the collection conduit 24, such that wastewater in the collection conduit is heated. In particular, the WHRU 40 may be a heat exchanger, such as a shell and tube, a plate and frame, or a bronzed plate heat exchanger. The WHRU 40 may be an air to water heat exchanger, with hot air from the secondary heat source 50 heating the wastewater in the collection conduit 24.

Accordingly, the system may be configured to have water treatment capability, when wastewater flow requirements exceed available solar energy. In other words, the heat collected from the secondary heat source 50 may supplement or substitute for the heat collected by the solar collector 30, by heating wastewater in the collection conduit 24 via the WHRU 40.

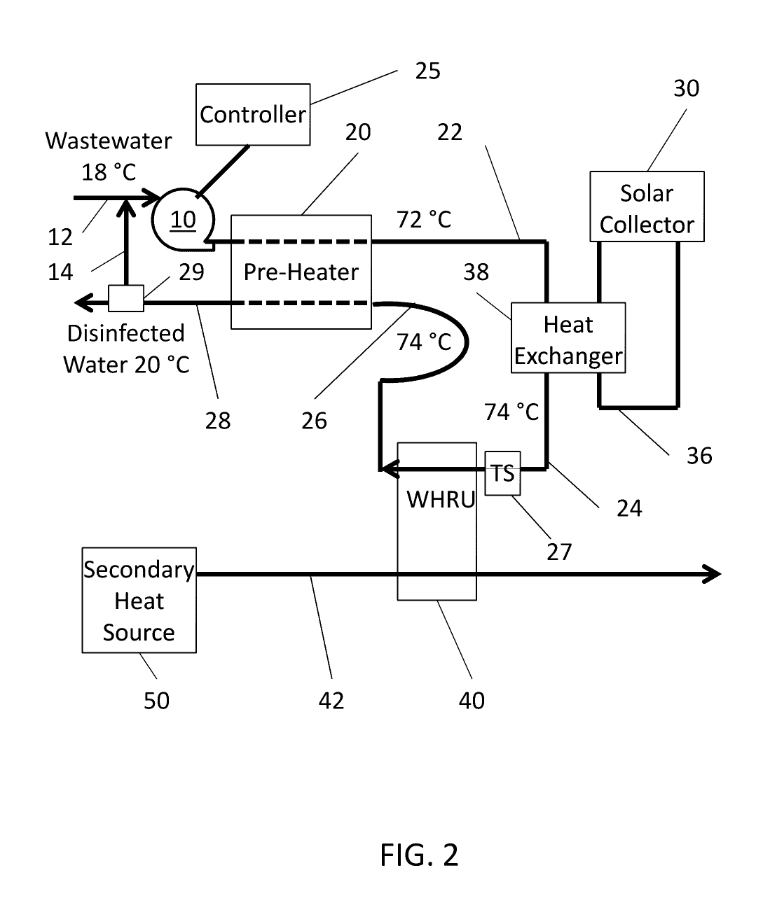

According to some embodiments, such as the embodiment shown in FIG. 2, a fluid other than wastewater may be circulated through the absorption conduits 34, and heat from the fluid may be transferred to the wastewater through an additional heat exchanger. The choice of fluid being heated depends on the solar collector type and freeze protection requirements at the location of the installation. The most commonly used fluids are water, water/propylene glycol mixtures, and air.

FIG. 2 is a schematic diagram of a wastewater disinfection system, according to various embodiments of the present disclosure. The system is similar to the system of FIG. 1, so only the differences therebetween will be discussed in detail.

Referring to FIG. 2, the system includes a solar collector 30 that is configured to circulate a fluid other than wastewater. The fluid is heated in the solar collector 30 and then fed through a circulation conduit 36 connected to a heat exchanger 38. The heat exchanger 38 is configured to transfer heat from the fluid to the wastewater received from the distribution conduit 22 and then supplied to the collection conduit 24.

Accordingly, the fluid may be configured to resist freezing, such that the system may be operated in areas that experience sub-freezing temperatures. The heat exchanger 38 may have any of the above-described heat exchanger configurations.

FIG. 3 is a schematic of components of the secondary heat source 50, when exemplified as a combined heat and power system, according to various embodiments of the present disclosure. Referring to FIG. 3, the secondary heat source 50 may include an ignition chamber 100, a turbine 110, and an electrical generator 120. The secondary heat source 50 may also include a blower or compressor 130, a compressor 140, and a burner 150.

A fuel conduit 162 may connect the compressor 140 and the burner 150 to a fuel supply 160. The fuel supply 160 may be a conduit, such as a natural gas pipeline, or may be a fuel storage tank containing a hydrocarbon fuel. The hydrocarbon fuel may be, for example, natural gas, methane, propane, or butane. However, other fuels may also be utilized. The compressor 140 operates to compress the fuel and then supply the compressed fuel to the ignition chamber 100. In particular, fuel at a relatively low pressure (e.g., 80-120 psig) may flow from the fuel supply 160 to the compressor 140. The compressor 140 may then further pressurize the fuel to a relatively high pressure (e.g., 300-340 psig) and supply the highly pressurized fuel to the ignition chamber 100. At the same time, the blower or compressor 130 may operate to feed room temperature air into the ignition chamber 100.

The ignition chamber 100 may include an igniter (not shown), such as an electric spark generator, a flame generator, or other like apparatus. In the ignition chamber 100, the pressurized fuel mixes with the air and is ignited, producing a gaseous exhaust having a high temperature and a pressure.

The exhaust is fed at high speed from the ignition chamber 100 to the turbine 110 through a turbine inlet conduit 102. The high-speed flow of exhaust causes blades of the turbine 110 to rotate, producing rotation in an output shaft 112 connecting the turbine 110 to the electrical generator 120. The electrical generator 120 converts this rotation into electricity.

Exhaust from the turbine 110 is fed to the exhaust conduit 42. The burner 150 may be disposed on the exhaust conduit 42 downstream from the turbine 110 and upstream from the WHRU 40, with respect to a flow direction of the exhaust. The burner 150 may receive fuel from the fuel supply 160 and may include an igniter similar to the ignition chamber 100. An optional second blower or compressor 131 may provide air to the burner 150, which allows the burner 150 to operate as independent heat source. The burner 150 may ignite the fuel to supply additional heat to the exhaust stream. In some embodiments, the burner 150 may receive compressed fuel from the compressor 140. However, in other embodiments, the burner 150 may be omitted.

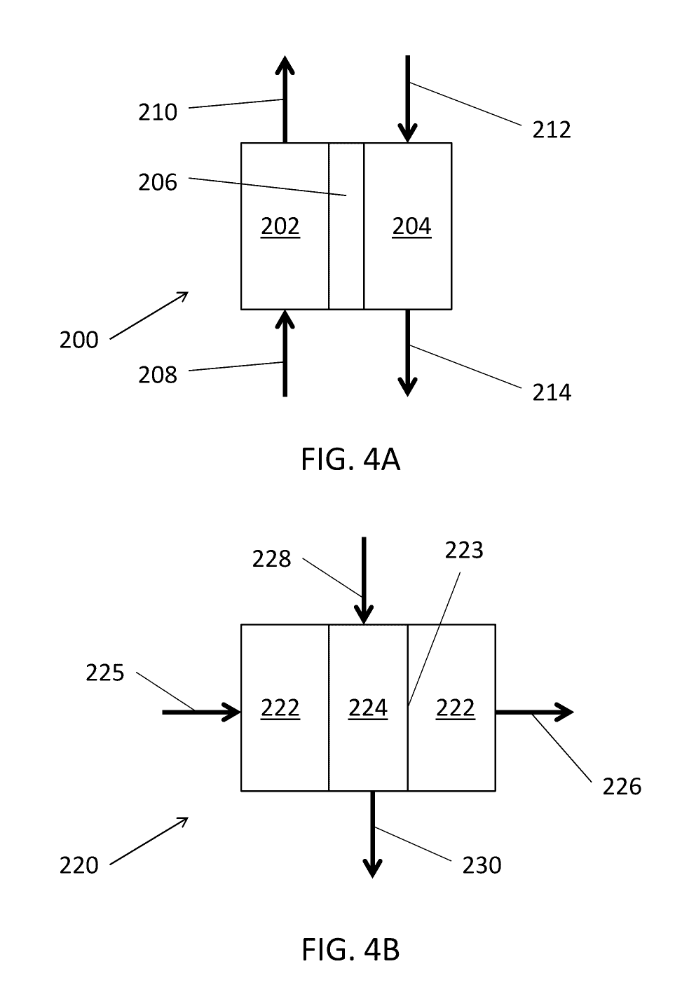

FIGS. 4A and 4B respectively illustrate heat exchangers 200, 220 that may be included in the wastewater disinfection system of FIGS. 1 and 2, according to various embodiments of the present disclosure. In particular, the heat exchangers 200, 220 may be included in, or used as, the pre-heater 20, the heat exchanger 38, and/or the WHRU 40 described above.

Referring to FIG. 4A, the heat exchanger 200 may include a first chamber 202, a second chamber 204, which are separated by a partition 206. A first fluid may flow into the first chamber 202 through an input conduit 208, and out of the first chamber 202 through an output conduit 210. A second fluid may flow into the second chamber 204 through an input conduit 212, and out of the second chamber 204 through an output conduit 214.

When the heat exchanger 200 is included in the pre-heater 20, the first and second fluids may both be wastewater streams having different temperatures. When the heat exchanger 200 is included in the heat exchanger 38 or the WHRU 40, one of the first and second fluids may be wastewater, and the other may be a fluid included in the solar collector 30 or hot exhaust, respectively.

As such, the heat exchanger 200 may be a counter-current heat exchanger having a counter current fluid flow. However, in other embodiments, the input and output conduits of one of the chambers 202, 204 may be reversed, such that the heat exchanger 200 may be a co-flow heat exchanger having a co-current flow. In some embodiments, the heat exchanger may be a cross-flow heat exchanger having a cross-current fluid flow. Heat may be exchanged between the first and second fluids through the partition 206.

Referring to FIG. 4B, the heat exchanger 220 includes an outer chamber 222 and an inner chamber 224, which are separated by a partition 223. The outer chamber 222 may surround the inner chamber 224. For example, the inner chamber 224 may be columnar, and the outer channel 222 may be annular.

A first fluid may flow into the outer chamber 222 through an input conduit 225 and may exit the first chamber through an output conduit 226. A second fluid may flow into the inner chamber 224 through an input conduit 228 and may exit the first chamber through an output conduit 230.

When the heat exchanger 220 is included in the pre-heater 20, the first and second fluids may be wastewater streams having different temperatures. When the heat exchanger 200 is included in the heat exchanger 38 or the WHRU 40, one of the first and second fluids may be wastewater, and the other may be a fluid included in the solar collector 30 or hot exhaust, respectively.

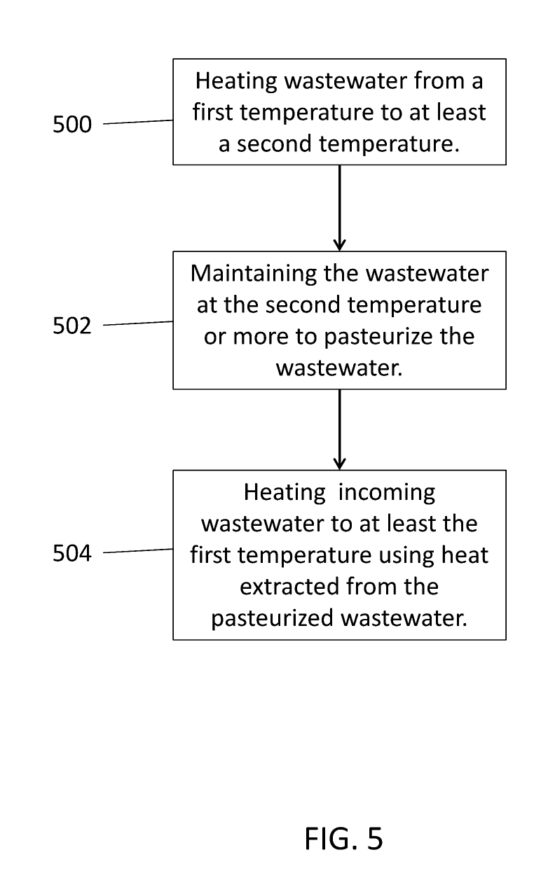

FIG. 5 is a block diagram illustrating a method of disinfecting wastewater, according to various embodiments of the present disclosure. The method may be performed using the system of FIG. 1 or FIG. 2, according to some embodiments.

Referring to FIG. 5, in operation 500, the method includes heating wastewater from a first temperature to at least a second temperature. The heating may be performed using the solar collector 30. In other embodiments, the heating may be performed using the WHRU 40 and secondary heat source 50, or a combination thereof and the solar collector 30.

In operation 502, the method includes maintaining the wastewater at least at the second temperature, for a time period sufficient to disinfect (e.g., pasteurize) the wastewater. The time period may be controlled by controlling a flow rate of the wastewater using the pump 10.

In operation 504, the method includes heating incoming wastewater to at least the first temperature using heat extracted from the disinfected (e.g., pasteurized) wastewater. The heat may be transferred to the incoming wastewater using the pre-heater 20. In some embodiments, operation 504 may include recycling wastewater output from the pre-heater back to the pre-heater during, for example, system startup, until the wastewater reaches the second temperature.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A solar wastewater disinfection system comprising:
a solar collector configured to heat wastewater from a first temperature up to at least a second temperature using solar energy;
a pre-heater configured to heat the wastewater up to at least the first temperature, by transferring heat from the wastewater heated by the solar collector;
a pump configured to circulate the wastewater between the pre-heater and the solar collector; and
a controller configured to control the pump, such that the wastewater is maintained at least at the second temperature for a time period sufficient to disinfect the wastewater.

2. The system of claim 1, wherein the first temperature ranges from about 69° C. to about 75° C.

3. The system of claim 1, wherein the second temperature ranges from about 72° C. to about 76° C.

4. The system of claim 1, wherein the controller is configured to control the pump, such that the wastewater is maintained at least at the second temperature for a time period ranging from about 10 to about 20 seconds.

5. The system of claim 1, wherein the controller is configured to control the pump, such that the wastewater is maintained at least at the second temperature for a time period of about 15 seconds.

6. The system of claim 1, further comprising:
a distribution conduit connecting an outlet of the pre-heater to an inlet of the solar collector; and
a collection conduit connecting an outlet of the solar collector to an inlet of the pre-heater.

7. The system of claim 6, further comprising a contact chamber disposed between the collection conduit and the pre-heater, wherein the contact chamber has a larger diameter than a diameter of at least one of the distribution conduit and the return conduit.

8. The system of claim 1, further comprising:
a secondary heat source; and
a waste heat recovery unit (WHRU) configured to transfer heat generated by the secondary heat source to the wastewater,
wherein the secondary heat source is a combined heat and power system comprising a turbine and an electrical generator.

9. The system of claim 8, wherein:
the system does not include a condenser; and
the controller is configured to operate the pump, such that the wastewater is maintained at a temperature of below 100° C. between the distribution conduit and the collection conduit.

10. The system of claim 1, wherein the solar collector is configured to directly heat the wastewater using solar energy by circulating the wastewater through the solar collector.

11. The system of claim 1, further comprising a heat exchanger configured to transfer heat from a fluid heated by the solar collector to the wastewater.

12. The system of claim 1, wherein the solar collector comprises tubes disposed in parabolic reflectors or flat-plate collectors.

13. The system of claim 1, further comprising a temperature sensor configured to detect a temperature of the wastewater in the system,
wherein the controller is configured to control the speed of the pump according to the detected temperature.

14. The system of claim 1, wherein the solar collector is floated on a body of water.

15. The system of claim 1, further comprising:
an input channel configured to connect the pump to an external wastewater source;
an output channel configured to connect an output of the pre-heater to an external wastewater destination; and
a recycling conduit configured to selectively connect the input channel to the output channel.

16. A method of disinfecting wastewater, comprising:
heating wastewater from a first temperature to at least a second temperature using heat from a solar collector;
maintaining the wastewater at least at the second temperature, for a time period sufficient to disinfect the wastewater; and
heating incoming wastewater to at least the first temperature using heat extracted from the disinfected wastewater.

17. The method of claim 16, wherein heating wastewater from a first temperature to at least a second temperature comprises using heat from both a combined heat and power system and the solar collector, to heat the wastewater.

18. The method of claim 16, wherein maintaining the wastewater at least at the second temperature comprises controlling a flow rate of the wastewater based on a temperature of the wastewater.

19. The method of claim 16, wherein heating incoming wastewater to at least the first temperature comprises using a heat exchanger and a closed circulation loop, until the wastewater reaches the first temperature.

20. The method of claim 16, wherein the solar collector floats on a body of water.
